(19) United States
(12) Patent Application Publication
(10) Pub. No.: US 2013/0157509 A1
(43) Pub. Date: Jun. 20, 2013

(54) APPARATUS FOR CONVERTING REMOTE CONTROL SIGNALS

(71) Applicants: Apoorv Srivastava, Franklin Park, NJ (US); Erik C. Metz, Chalfont, PA (US); Clyde N. Robbins, Maple Glen, PA (US)

(72) Inventors: Apoorv Srivastava, Franklin Park, NJ (US); Erik C. Metz, Chalfont, PA (US); Clyde N. Robbins, Maple Glen, PA (US)

(73) Assignee: General Instrument Corporation, Horsham, PA (US)

(21) Appl. No.: 13/325,680

(22) Filed: Dec. 14, 2011

(51) Int. Cl. H01R 13/40

(52) U.S. Cl. 439/625

(57) ABSTRACT

A dongle for converting remote control instructions from a first wireless medium to a second wireless medium includes a base unit having a base unit housing. A receiver disposed within the base unit housing is operable to receive a remote control instruction via the first wireless medium. A communication module including a communication module housing includes a transmitter operable to transmit the remote control instruction via the second wireless medium. The communication module is coupled to and pivotable with respect to the base unit.

### FIELD OF THE INVENTION

The present invention relates to a dongle for facilitating remote control of an electronic device.

### BACKGROUND

Remotely controlled electronic devices are abundant in many homes today. Unfortunately, the proliferation of remotely controlled devices has also led to a proliferation of remote control units, which creates clutter and generally complicates the user experience. Many attempts have been made to address this problem. For example, there are many models of universal remote controls on the market. Having a universal remote control reduces the number of remote controls needed in a home, but a universal remote control still adds to the clutter of a home. Furthermore, universal remote controls are generally limited to one wireless technology, such as infrared (IR). Remote controls using multiple wireless technologies tend to be expensive.

Some products on the market attempt to enable the use of a smartphone or tablet computer to be used as a remote control. One problem with this approach is that smartphones and tablet computers do not always include circuitry and software necessary to enable the same communication technologies as other electronic devices. For example, smartphones often do not include IR transceivers, whereas many electronic devices are controlled by IR.

There are products that attempt to bridge this gap by providing a unit that includes both a short range radio frequency (RF) transceiver, such as those complying with the Bluetooth® standard, which most smartphones, laptop computers, and tablet computers are capable of using, and IR. However, these products are typically housed in a separate, battery-powered unit that sits, for example, on a table in the media room and adds clutter. Furthermore, such products are not typically capable of easily directing remote control signals at particular targets without moving the entire device.

### BRIEF DESCRIPTION OF THE DRAWINGS

Various embodiments of the present invention will be described below in more detail, with reference to the accompanying drawings.

It is to be noted, however, that the appended drawings illustrate embodiments of this invention and are therefore not to be considered limiting of its scope, for the invention may admit to other equally effective embodiments. For example, the embodiments of the invention described herein can be realized in hardware, software, or a combination of hardware and software.

FIGS. 1a and 1b illustrate embodiments of the invention;

FIG. 2 illustrates an implementation of the base unit;

FIG. 3 illustrates a circuit that may be used in conjunction in the communication module;

FIGS. 4a-4e illustrate examples of how the base unit and the transceiver module may be connected to one another;

FIGS. 5a and 5b illustrate examples of how the translator may be plugged into other devices;

FIG. 6 illustrates an example of a system in which an embodiment of the invention may be used;

FIG. 7 illustrates a user interface according to an embodiment of the invention; and

FIG. 8 is a flowchart showing an example of how an embodiment of the invention operates.

### DETAILED DESCRIPTION

In accordance with the foregoing, an apparatus and method for converting remote control signals will now be described. In some embodiments, the apparatus is a remote control translator implemented as a dongle that plugs into a port providing a power source (such as a USB port of a set-top box) and converts remote control signals (for example, received from a smartphone or computer) compliant with one wireless medium via one communication link (for example standard compliant RF signals such those communicated over a Bluetooth® link) into signals compliant with another medium communicated on another communication link (such as an IR link), thereby allowing multiple types of electronic devices to be controlled from a smartphone or computer. In one embodiment, the dongle is hinged, with a base unit (which receives remote control commands in one format) on one side of the hinge, and a communication module (which translates the remote control commands to another format). The hinge allows the communication module to be positioned to direct signals, which is particularly beneficial when such signals are unidirectional, as in the case of infrared signals.

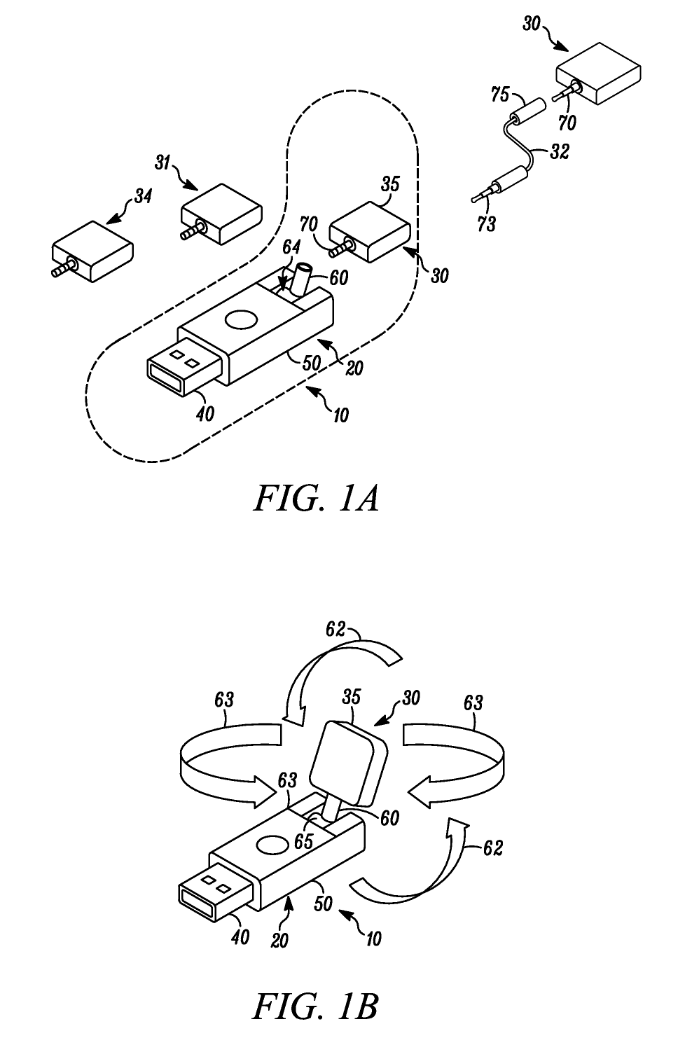

Referring to FIGS. 1A and 1B, an exemplary embodiment of the translator will now be described. The translator, generally labeled 10, includes a base unit 20 and a plug-in communication module 30. The base unit 20 includes a housing 50. A quick-disconnect component connector 40 is carried on the housing. The component connector 40 can be implemented using any commercially available connector of the type provided on electronic components such as home audio equipment, media devices, video equipment, computers, or the like, and may, by way of example, be a universal serial bus (USB) connector, a high definition multi-media interface (HDMI), a micro-HDMI connector, an RJ45 connector, an RJ11 connector, or the like.

The base unit 20 further includes a quick-disconnect module connector 60. The illustrated module connector 60 is a jack socket, and more particularly is illustrated as a female jack-socket connector of the type used for audio headsets. However, the module connector 60 can be implemented using any suitable commercially available connector, male or female, that permits the connection and disconnection of the communication module 30. In the illustrated embodiment, the component connector 40 extends from one end of the housing 50, while the module connector 60 extends from the opposite end of housing 50.

The communication module 30 has a housing 35 and a base connector 70 extending from the housing 35. By way of example, the base connector 70 can advantageously be implemented using a jack plug, which may, for example, be configured as a tip/sleeve, tip/ring/sleeve, or a tip/ring/ring/sleeve plug. In an embodiment of the invention, the module connector 60 and base connector 70 are an audio jack socket and an audio jack plug, (e.g., a 3.5 or 2.5 millimeter audio jack socket and a 3.5 or 2.5 millimeter audio jack plug), respectively. The module connector 60 receives the base connector 70 so that the base connector 70 fits snugly into the module connector 60, is readily detachable from the module connector 60, but is still able to rotate within the module connector 60, thereby allowing the housing 35 of the communication module 30 to rotate with a 360° range of lateral motion (as symbolized by the arrows 63). Rotation of the communication module 30 allows, for example, IR signals to be directed toward the appropriate electronic devices and/or allows the IR signals to bounce off various objects nearby to flood the vicinity with IR, or to bounce off walls to be reflected to the IR target over a longer transmission path. Other types of plugs and sockets, or other types of connections may be used to implement the base connector 70 and the module connector 60, such as an RCA jack and socket, a micro-USB jack and socket, an RJ45 jack and socket, a high-definition multimedia interface jack and socket and an RJ11 jack and socket. In another implementation of the communication module 30 shown in FIG. 1A, the base connector 70 is electrically connected to the rest of the communication module 30 by a flexible wire 32, which will allow a great deal of flexibility in steering the communication module 30 to reach a desired target regardless of the type of base connector used. The flexible wire 32 provides flexibility for positioning of the communication module 30 even if the base connector 70 is fixed and does not permit movement. At one end of the flexible wire 32 is a connector 73 that is configured in the same manner as the base connector 70 and is plugged into the module connector 60 of the base unit 20. At the other end of the flexible wire 32 is a connector 75 that is configured in the same manner as the module connector 60 of the base unit 20. The base connector 70 of the communication module 30 is plugged into this connector 75. The connector 73 on the flexible wire is, in turn, connected to the module connector 60.

FIG. 1A depicts the communication module 30 as being detached from the base unit 20. However, during operation of the translator 10, the communication module 30 is attached to the base unit 20, as shown in FIG. 1B. According to an embodiment of the invention, the communication module 30 of the translator 10 can be swapped out for other communication modules. For example, referring to FIG. 1a, the communication module 30 may be an IR unit, a second communication module 32 may be a Zigbee® unit (capable of sending and/or receiving signals according to, for example, the IEEE 802.15.4 standard), and a third communication module 34 may be a Zwave unit (capable of sending and/or receiving signals according to the Zwave protocol). This allows the translator 10 to be easily reconfigured from one type of converter (for example, Bluetooth® to IR) to another type of converter (for example, Bluetooth® to Zigbee® or Ethernet or 802.11). Those skilled in that art will recognize that modules providing other communication protocols could be supported without departing from the invention.

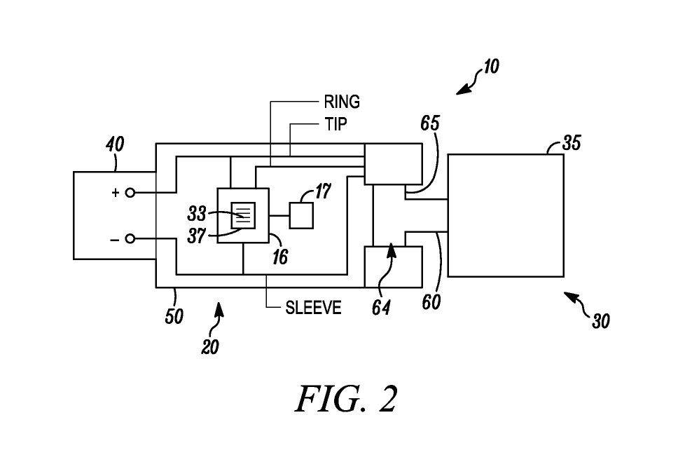

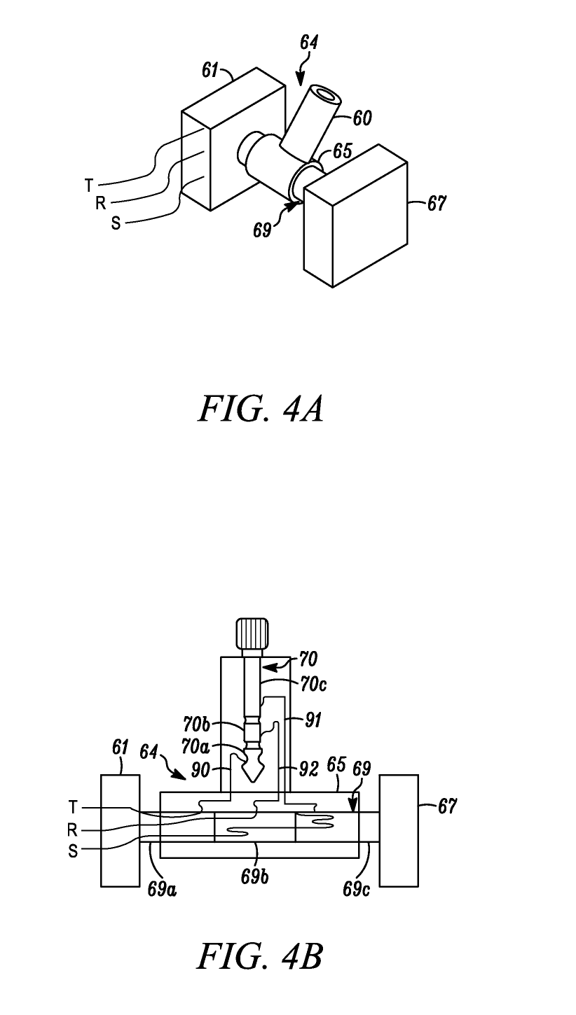

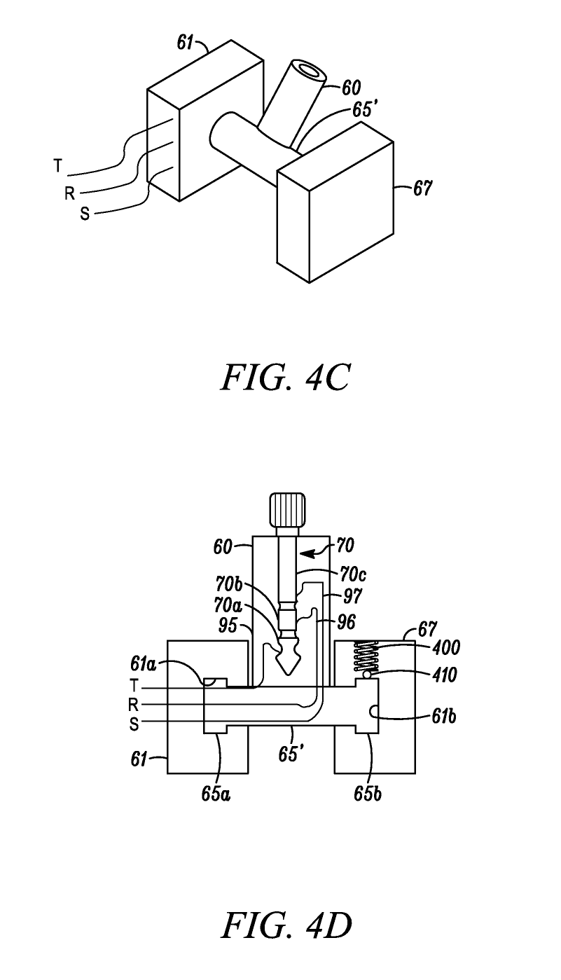

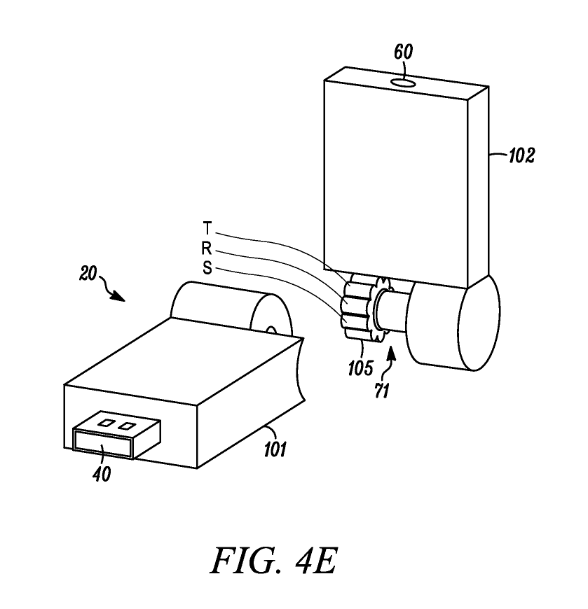

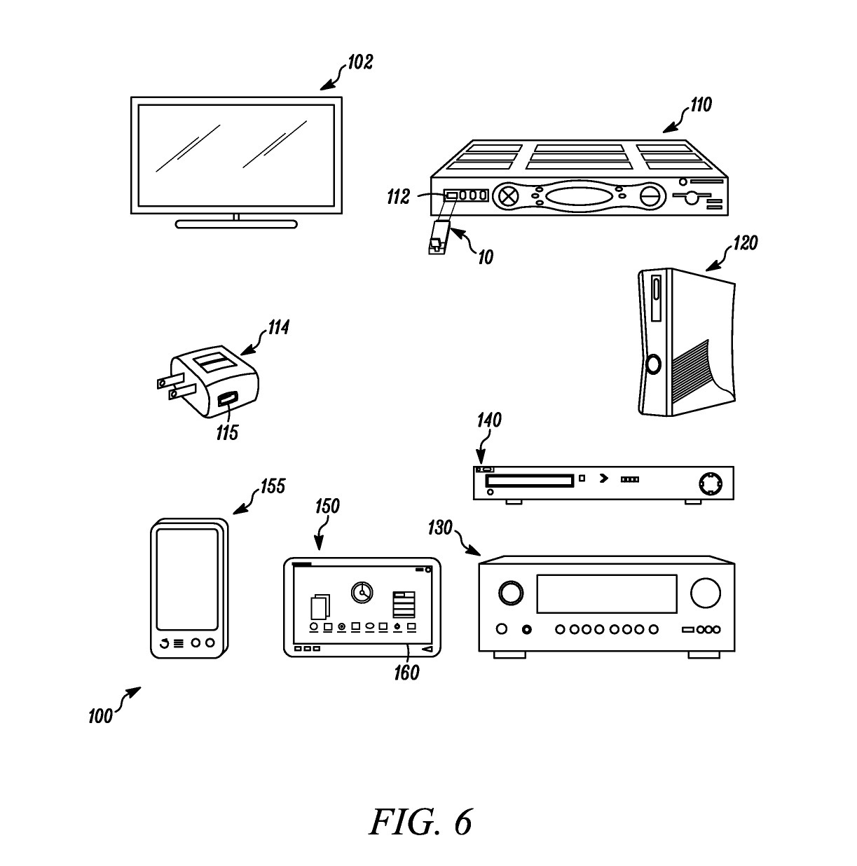

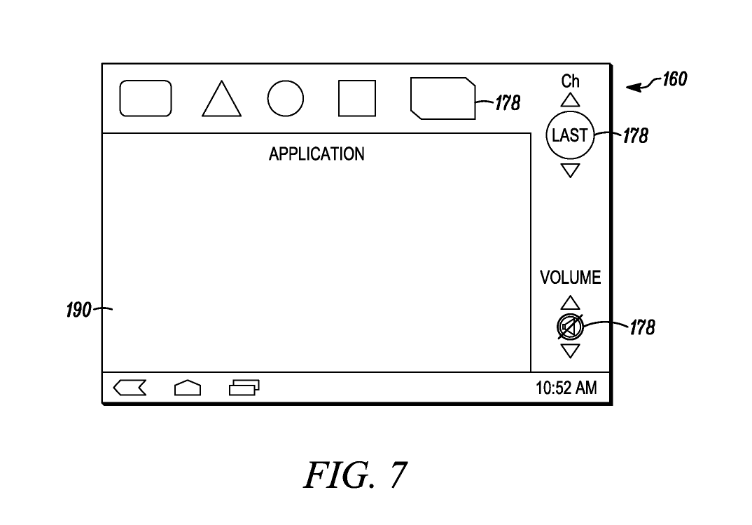

In one illustrative embodiment, the base unit 20 from FIGS. 1A and 1B may include a transceiver capable of communicating via a first wireless medium, such as an RF link using a Bluetooth® protocol. For example, FIG. 2 depicts a circuit in the base unit 20 having a controller 16 that receives power via the component connector 40. The power from the component connector 40 is provided via the conductive path labeled TIP, which is also electrically connected to the tip of the module connector (70a in FIGS. 4a and 4d). The controller 16 provides data via the conductive path labeled RING, which is also electrically connected to the ring of the module connector (labeled 70b in FIGS. 4a and 4d). The negative or ground connection from the component connector 40 is electrically connected to the controller 16 and to the sleeve of the module connector (labeled 70c in FIGS. 4a and 4d) by the conductive path labeled SLEEVE. In other embodiments, the roles of the tip 70a and ring 70b could be reversed, with the tip 70a being used for data and the ring 70b being used for power and the appropriate wires being attached thereto. The controller 16 receives wireless signals via an RF transceiver 17, which, in turn, receives the signals wirelessly from a remote control (such as from the tablet computer 150 or the smartphone 155 of FIG. 6). The controller 16 converts the data carried by those signals from a first wireless medium which, in this embodiment, is a Bluetooth® protocol to remote control commands oriented to a second wireless medium, such as an IR, Zigbee®, or Zwave protocol. Alternatively, the controller 16 receives, via Bluetooth® signals, remote control commands that were carried over the first medium, but already oriented for the component requiring reception over the second wireless medium (such as IR, Zigbee® or Zwave), and controls a compliant communication module 30 to transmit those signals via the second wireless medium. The controller 16 and RF transceiver 17 can be implemented in a single integrated circuit, such as a Texas Instruments TI CC2564 integrated circuit, that includes both a processor and a transceiver that implements RF communications. Another possible implementation of the controller 16 is a system-on-a-chip (SOC) module that includes both a USB controller that controls the flow of power through the component connector 40 and a processor that can control both the RF communications of base unit 20 and the communications with the remotely controlled electronic device via the communication module 30.

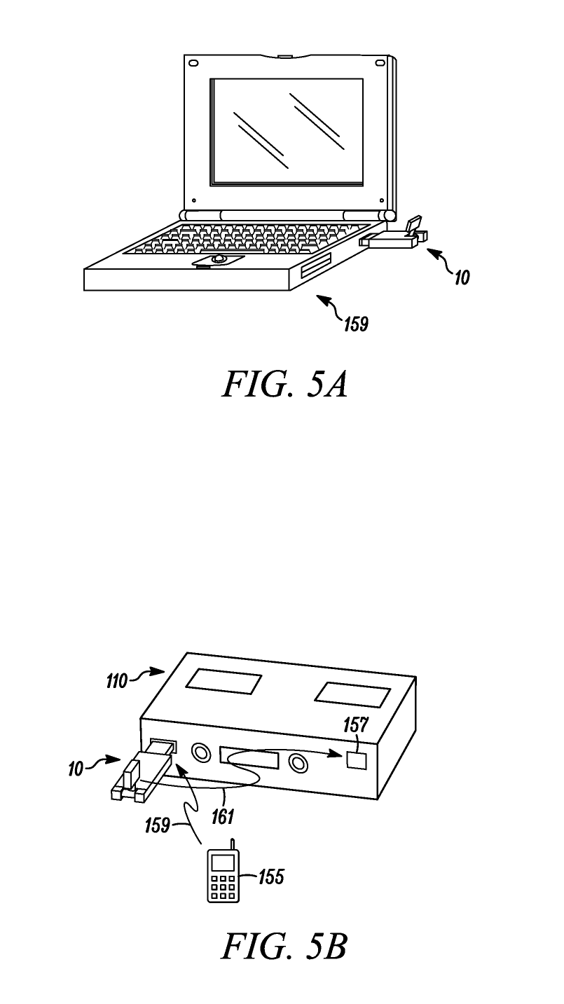

In order to implement the communications to and from the translator 10 (FIG. 2), it is envisioned that the necessary drivers will be stored in the base unit controller 16. In one embodiment, the controller 16 includes a memory 32, with the applications and codes for the first and/or second wireless mediums stored in a code library 33 in the memory 32. The code library 33 can optionally be a subset of a larger code library that is stored on a source device, such as the tablet computer 150 or the smartphone 155 of FIG. 6. It is envisioned that the larger code library on the source device can store codes for many brands and models of electronic devices, whereas the code library 33 stores only the subset of the codes necessary for the device brands and models of the system 100 (FIG. 6). However, with a suitably large memory, the code library 33 may contain information for all brands and models. From the larger code library, the tablet computer 150 or smartphone 155 transmits the subset of codes necessary for the device brands and models of the system 100 to the base unit 20 during initial setup. Alternatively, the source device may be a notebook computer 159 (shown in FIG. 5A), and the necessary drivers, applications, and/or codes can be downloaded directly through the component connector 40 during initialization. Optionally, once the base unit 20 is set up to communicate with the source device via the first communication medium, the control codes that allow the communication module 30 to communicate with the remotely controlled devices via the second communication medium can be downloaded to the base unit 20 through the first communication medium. In yet another embodiment, the tablet computer 150 or smartphone 155 performs the translation between remote control codes of the first communication medium to remote control codes of the second communication medium in real-time, thereby eliminating the need for any of the translation to be performed by the base unit controller 16.

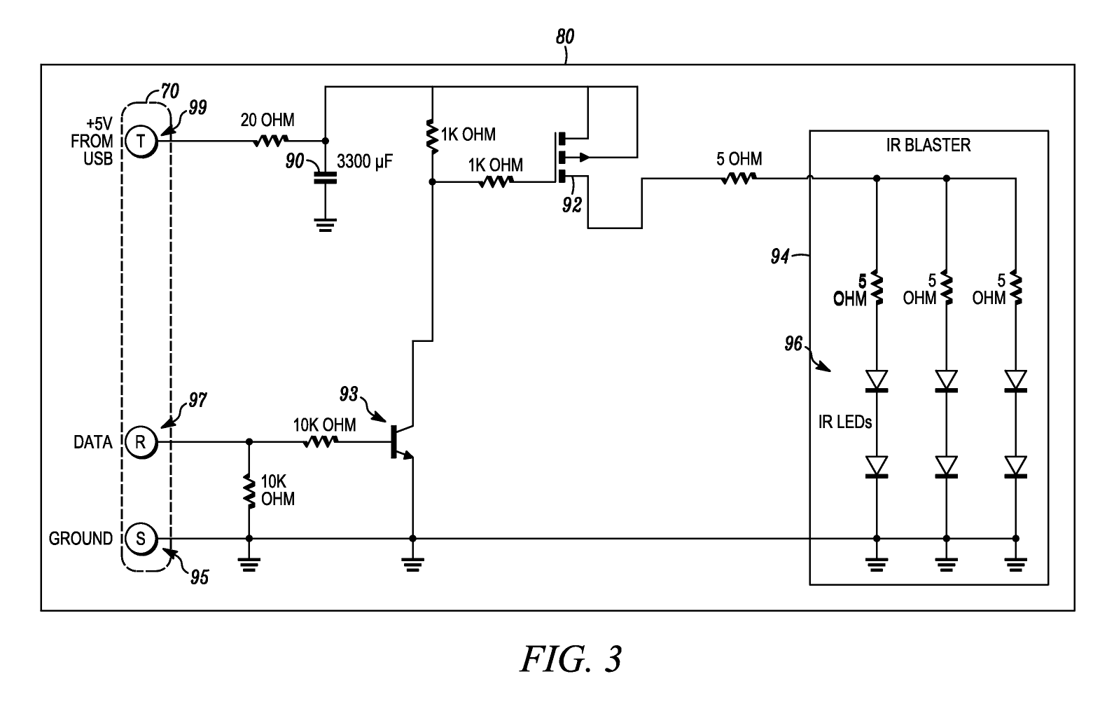

Referring to FIG. 3, an embodiment of the communication module 30 will now be described. A circuit 80 is disposed within the housing 35 of the communication module 30 (from FIG. 1a). The circuit 80 provides an IR transmitter module. The circuit 80 receives data and power via the base connector 70. More specifically, a first terminal 95 is connected to receive ground from the base unit 20. A second terminal 97 is connected to receive data signals from base unit 20. A third connector 99 is connected to receive positive supply voltage from base unit 20. Where a jack plug is used as the base connector 70, a tip/ring/sleeve plug can be advantageously employed, and the respective tip, ring, and sleeve portions of the jack plug are terminals 99, 97, and 95, respectively, and electrically connect to the circuit 80 in FIG. 3, with the T in FIG. 3 representing the tip, the R representing the ring, and the S representing the sleeve. The circuit 80 includes a capacitive element 90 (which in this embodiment is a 3300 μF capacitor) that charges using current from the base connector 70.

Continuing with FIG. 3, the circuit 80 further includes a transistor 93, the base of which is connected to data terminal 97. The collector of transistor 93 is connected to base of transistor switch 92. The transistor switch 92 is connected between the capacitor 90 and the IR blaster unit 94. When the communication module 30 is controlled transmit an IR signal (such as to the components of the system 100 in FIG. 3 in response to remote control instructions received from the tablet computer 150), the switch 92, responsive to the data at terminal 97 driving transistor 93, is controlled to discharge from capacitor 90 current to drive the IR blaster unit 94. The IR blaster unit 94 includes IR light emitting diodes (LEDs) 96 (six are shown in FIG. 2 but other groupings may be used) to flood the area around the translator 10 with an IR emission when power is supplied via the switch 92. The IR emission contain signals providing remote control instructions to control one or more electronic devices (such as the devices of the system 100 of FIG. 6). According to one embodiment, the current provided to the circuit 80 is at or below the USB limit of 500 mA and charges the capacitive element 90 to a level at which the capacitive element 90 is capable of discharging a current greater than 500 mA to the IR blaster unit 94, thereby energizing the IR LEDs 96. This step up power supply provides a larger magnitude of power to the blaster unit 94 than that available from the component connector 40, such that the input power supply does not limit the IR signal magnitude output by the IR blaster unit 94.

As discussed previously in conjunction with FIG. 1A, the base unit 20 and the communication module 30 may be connected to one another (both mechanically and electrically) via a module connector 60 and a base connector 70, which may be implemented as a tip/ring/sleeve jack and plug respectively. One exemplary assembly for implementing the hinge assembly 64 in the base unit 20 is shown in more detail in FIGS. 4A and 4B. The hinge assembly 64 is supported between a first panel 61 and a second panel 67. A cylindrical tube 65 is rotatable around a multi-conductor cylinder 69 in a manner that is independent of the first and second panels 61 and 67. This allows the module connector 60 to swing from a position where, when the base unit 20 is connected to the communication module 30, the top of the housing 50 of the base unit 20 and the housing 35 of the communication module 30 make contact, to a position where the bottom of the housing 50 of the base unit 20 and the housing 35 of the transceiver module 30 make contact (approximately a 270° range of motion, as symbolized by the arrows 62 in FIG. 1 B). In FIGS. 4A and 4B, the cylindrical tube 69a, 69b, or 69c may be coupled to a ratchet gear (not shown) and pawl (not shown). In FIG. 4C, the cylindrical tube 65 may be coupled to a ratchet gear (not shown) located in either the first panel 61 or the second panel 67. The ratchet gear along with a pawl (not shown) would lock the cylindrical tube 65 in place so that the module connector 60 and the attached communication module 30 can maintain a constant position or allow a click-to-click movement.

The module connector 60 can be attached to the cylindrical tube 65 to form an assembled member, or the module connector 60 can be integrally formed with the cylindrical tube 65, and may for example comprise a single piece of molded plastic including the tube 65 and sleeve of the module connector 60. The multi-conductor cylinder 69 comprises multiple electrically isolated conductive members, and may be a manufactured of a non-conductive cylinder with a first conductive outer ring 69a, a second conductive outer ring 69b and a third conductive outer ring 69c. The first, second and third conductive rings 69a, 69b and 69c are electrically isolated from one another even if they are carried on a common member. The hinge assembly 64 includes a first conductive blade 90 (FIG. 4b) making electrical contact with the first conductive ring 69a and the tip 70a of base connector 70 when the base connector 70 is inserted in the module connector 60, a second conductive blade 91 making electrical contact with the middle conductive ring 69b and the ring 70b when the base connector 70is inserted in the module connector 60, and a third conductive blade 92 making electrical contact with an outer conductive ring 69c and the sleeve 70c when the base connector 70 is inserted in the module connector 60. Furthermore, the rings 69a, 69b, and 69c are connected to the Tip (T), Ring (R) and Sleeve (S) wires of the base unit 20 (FIGS. 3, 4a, and 4b). More specifically, a first wire T is electrically connected to the first ring 69a to transfer power from the base unit 20 to the communication module 30, a second wire R is electrically connected to the second conductive ring 69b to transfer data from the base unit 20 to the communication module 30, and the third wire S is electrically connected to the third conductive ring 69c to provide a common ground for the base unit 20 and the communication module 30.

Referring to FIGS. 4C and 4D, an alternative arrangement for connecting the communication module 30 and the base unit 20 will now be described. In this embodiment, the cylindrical tube 65′ is dumbbell-shaped having opposite ends that have a larger diameter than the center extension, to create a disc tongues 65a, 65b at opposite ends of the cylindrical tube 65′. In one embodiment, a spring 400 is attached to an inside wall of the second panel 67. The spring 400 is in tension and exerts force on a ball bearing 410, which in turn exerts force on one of the tongues 65b. The tongue 65b may be dimpled or toothed to receive the bearing 410 to act as a ratchet mechanism, thereby allowing click-to-click movement of the module connector 60. The core of the cylindrical tube 65′ is hollow to allow the T, R, and S wires to pass through. The first panel 61 and the second panel 67 in this embodiment include respective groove wells 61a, 61b for receipt of the tongues 65a and 65b. The tongues 65a and 65b at the ends of the cylindrical tube 65′ sit in and cooperate with the grooves to permit rotation. In this embodiment, the wires T, R and S are connected to the ends of electrically conductive blades 95, 96 and 97 that connect to the tip 70a, ring 70b, and sleeve 70c of plug 70. The wires can be connected to the blades using solder, pinch connection, or other conventional means. The blades are mounted in the sleeve of the module connector 60 and include bent ends that make a wiping pressure connection to the plug 70.

Yet another arrangement for connecting the base unit 20 and the communication module 30 is shown in FIG. 4E. In this embodiment, the base unit includes a first housing 101, a second housing 102, and a hinge 71 that connects the first and second housings of the base unit 20. The module connector 60 is located on an end of the second housing 102 opposite the hinge 71. The hinge 71 is illustrated as an offset hinge having a ratchet gear 105 carried on the second housing 102 for receipt in a pivot opening in the housing 101. The larger diameter end of the bearing is held in a groove in the first housing 101 (not shown). The center of the bearing 105 is hollow to provide a conduit for wires T, R and S. The wires T, R and S are connected to blades (not shown) carried in the second housing 102 for electrical connection to the plug 70. The blades may be similar to blades 95, 96 and 97 (FIG. 4D). In FIG. 4E the ratchet gear 105 may interact with a pawl (not shown) to allow the second housing 102 to be locked to the first housing 101 or to allow the second housing 102 to be moved in a click-to-click motion.

The translator 10 from FIGS. 1a and 1b can be plugged into a variety of devices. FIG. 5a shows the translator 10 plugged into the USB port of a notebook computer 159. This configuration could be used during the initial setup of the translator 10, in which the setup software would execute on the notebook 159, download the appropriate device remote control commands, and transfer those commands to the data structure 33 (FIG. 3) stored in the controller 16. FIG. 5b shows the translator 10 connected to the USB port of a cable set-top box 110. In this configuration, a smartphone 155 (or other device) could transmit a remote control command via a first communication link 159 that is established via a first communication medium (such as Bluetooth®). The translator 10 would receive the command, convert the command into form suitable for a second communication link 161 established via a second communication medium (such as IR) and transmit the converted command via the second communication link 161 to a receiver 157 (which may be an IR receiver) on the set-top box 110 in order to control the actions of the set-top box 110.

Referring to FIG. 6, an example of a system that uses an embodiment of the invention is shown. The system 100 includes a cable set-top box 110 having a universal serial bus (USB) socket 112. A remote control translator 10 configured according to an embodiment of the invention is plugged into the USB socket 112 and receives electrical current from the set-top box 110 via the USB socket 112. The system 100 includes a game console 120, an audiovisual receiver unit 130, and a Blu-Ray player 140. The system 100 also includes a portable computing device, which in this embodiment is either a portable tablet computer 150 or a smartphone 155. The portable tablet computer 150 has a user interface 160 and controls the system 100 via the user interface 160. More specifically, the tablet computer 150 receives input from a user via the user interface 160, creates remote control commands based on the user input, and transmits those commands via a wireless communication technology (for example, Bluetooth®) to the remote control translator 10. The remote control translator 10, in turn, transmits corresponding commands via another wireless technology (for example, IR) to the set-top box 110, the game console 120, the audiovisual receiver unit 130, and/or the Blu-Ray Player 140. The user interface 160 may also be implemented on the smartphone 155. The user interface 160 may be downloaded to the tablet computer 150 or smartphone 155 as a mobile app from an online mobile app market via the Internet over, for example, an IEEE 802.11 protocol or a cellular network.

The user interface 160 of the tablet computer 150 may be implemented in a variety of ways. For example, referring to FIG. 7, one embodiment of the user interface 160 includes an activity-based control 178 that includes television remote control functionality. The “remote control commands” referred to herein may include any command that can be initiated from the user interface 160, including power on/off, programming guide selections, social networking commands, stored media selections, and the like. The user interface 160 also includes an application area 190, in which various applications may run, such as an electronic programming guide.

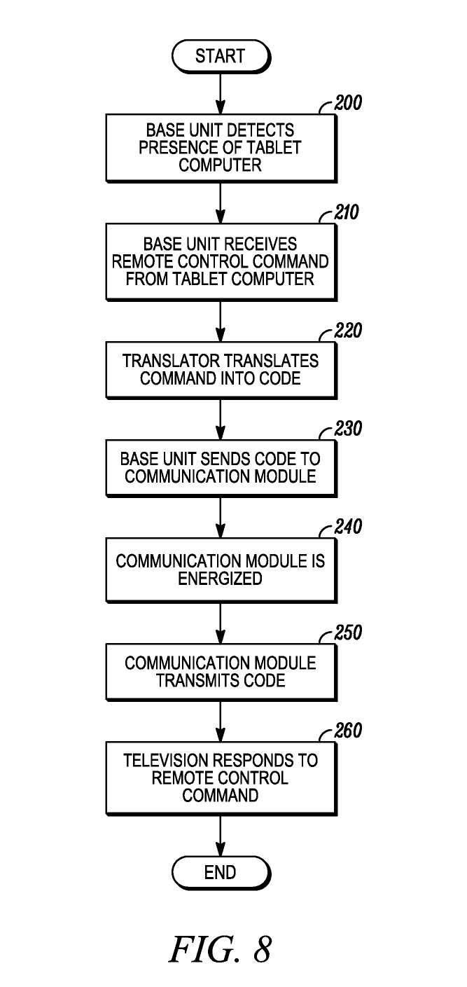

Referring to FIGS. 6 and 8, an example of how electronic devices may be controlled according to an embodiment of the invention will now be described. At step 200, the controller 16 of the base unit 20 detects the presence of the tablet computer 150. This could be accomplished, for example, after having been previously paired with the tablet computer 150 using a well-known Bluetooth® pairing process. At step 210, the controller 16 receives a remote control command (such as a “TV power on,” “volume up,” channel up,” etc.) from the tablet computer 150 via a first communication medium (e.g., a Bluetooth® message). At step 220, the translator 10 translates the remote control command into the appropriate code for the second communication medium (e.g., receiving a Bluetooth® “TV power on” command, looking up the command in the IR code library 32 stored in the memory 33 of the Controller of the unit 20, and generating the code for “TV power on” in an IR protocol). As previously discussed, in some embodiments the tablet computer 150 would contain an IR code library and would have performed the translation prior to step 210, thereby eliminating the need for step 220. At step 230, the base unit 20 sends the translated code to the data input 97 of the communication module 30 (FIG. 3). At step 240, the communication module 30 is energized (e.g., the switch 92 permits capacitor 90 (FIG. 3) of the communication module 30 to discharge current to the IR blaster unit 94), and permits a signal representing the translated code to flow (e.g., from the data input 96 to the IR blaster unit 94). At step 250, the communication module 20 transmits the code via the second communication medium (e.g., the IR LEDs 96 transmit an IR signal with the translated code). At step 260, the television 102 receives the signal and responds to the command (e.g., powers on, raises the volume, increments the channel, etc.)

The flowchart and diagrams in FIGS. 1 through 8 illustrate the architecture, functionality, and operation of possible implementations of systems and methods according to various embodiments of the present invention. In this regard, procedures outlines (for example, in flowchart of FIG. 8) may be implemented as a module, segment, or portion of code, which comprises one or more executable instructions for implementing the specified functions. It should also be noted that, in some alternative implementations, the functions noted may occur out of the order noted in the figures or in the text. For example, two steps shown or described in succession may, in fact, be executed substantially concurrently, or the steps may sometimes be executed in the reverse order, depending upon the functionality involved.

This invention can be embodied in other forms without departing from the spirit or essential attributes thereof. For example, although three connectors are described for the module connector and the base connector, more or fewer connectors could be supported. Additionally, although circuit 80 of FIG. 3 shows an IR transmitter, the circuit could implement an IR transceiver, an RF transmitter or receiver, or any circuitry to support any desired communication medium. Additionally, although the base unit is illustrated as being an RF transmitter supporting the Bluetooth® communication protocol, the circuitry can implement and desired communication medium. Accordingly, reference should be made to the following claims as indicating the scope of the invention.

1. A dongle comprising:
a base unit comprising a housing, a hinge assembly at one end of the housing, and a connector at the other end of the housing, wherein the connector is adapted to connect to a port of an electronic device; and
a communication module coupled to the base unit via the hinge assembly, wherein the communication module is readily detachable from the base unit and wherein the hinge assembly is pivotal with respect to the base unit, thereby permitting the communication module to be repositioned;
wherein the base unit and the communication module cooperate electrically to convert remote control signals received by the base unit over a first communication medium to remote control signals transmitted by the communication module over second communication medium.

2. The dongle of claim 1, wherein the hinge assembly comprises a module connector that is pivotal with respect to the base unit, and the communication module comprises a base connector adapted to be coupled with the module connector.

3. The dongle of claim 2, wherein the module connector is selected from a group consisting of an RJ45 connector, an RJ11 connector, universal serial bus (USB) connector, an audio jack connector, and a high-definition multimedia interface connector.

4. The dongle of claim 1,
wherein the hinge assembly comprises a plurality of conductors, each of the plurality being electrically connected to the base unit, and
wherein the communication module comprises a base connector comprising a plurality of conductors, each of the plurality being electrically connected to one of the plurality of the conductors of the hinge assembly.

5. The dongle of claim 1, wherein the base unit further comprises a first panel and a second panel, the hinge assembly being supported between the first and second panels.

6. The dongle of claim 1,
wherein the hinge assembly comprises a jack socket that is pivotal with respect to the base unit, and
wherein the communication module comprises a jack plug, the jack plug and jack socket being configured to couple with one another mechanically and electrically.

7. The dongle of claim 6, wherein the jack plug is chosen from a group consisting of an audio jack plug, an RJ45 plug, a high-definition multimedia interface plug and an RJ11 plug.

8. An apparatus for directing infrared control signals, the apparatus comprising:
a base unit comprising a connector configured to be coupled to a source of power, and a hinge assembly; and
an infrared communication module connected to the hinge assembly, the base unit transferring the power from the power source to the infrared communication module, wherein the infrared communication module is pivotal with respect to the base unit to direct the infrared control signals.

9. The apparatus of claim 8, wherein the communication module and the hinge assembly are connected via a plug and a jack such that the communication module is readily removable from the hinge assembly.

10. The apparatus of claim 8, wherein the plug and jack are configured as a tip, ring, sleeve plug and jack.

11. The apparatus of claim 8,
wherein the hinge assembly comprises a first panel, a second panel, and a cylindrical piece supported between the first and second panels for rotation about the long axis of the cylindrical piece, and
wherein the base unit further comprises a module connector and the communication module further comprises a base connector, the module connector being attached to the cylindrical piece.

12. The apparatus of claim 11, wherein the cylindrical piece comprises a disk tongue at each of its ends that are received by groove wells of the first and second panels and is rotatable therein.

13. The apparatus of claim 8, wherein the power source is a universal serial bus (USB) connector, an audio jack connector, an RJ45 connector, a high-definition multimedia interface connector and an RJ11 connector.

14. The apparatus of claim 11, further comprising a flexible wire having a first connector and a second connector, the first connector being adapted to be coupled to the module connector and the second connector being adapted to be coupled to the base connector.

15. The apparatus of claim 8, further comprising an electronic device, the source of power being integrated with the electronic device, the electronic device comprising an infrared receiver, the communication module being pivotable to direct infrared signals to the receiver.

16. A dongle for converting radio frequency remote control commands to infrared remote control commands, the dongle comprising:
a base unit comprising a housing, a universal serial bus connector extending from one end of the housing, a radio frequency receiver disposed within the housing, and a module connector disposed at the other end of the housing; and
a communication module comprising a housing, a base connector extending from the housing, and an infrared transmitter disposed within the housing,
wherein the communication module is physically and electronically connected to the base module via coupling of the module connector and the base connector and is pivotal with respect to the base unit, and
wherein the radio frequency receiver receives radio frequency signals representing remote control commands, the commands are communicated to the communication module via the module connector and the base connector, and the commands are transmitted via the infrared transmitter.

17. The dongle of claim 16, wherein the radio frequency receiver is integrated with a processor that translates the remote control commands from a radio frequency format to an infrared format.

18. The dongle of claim 16, wherein the base connector and the module connector are mated male and female jacks.

19. The dongle of claim 16, wherein the universal serial bus connector is connected to an electronic device and the commands control the electronic device.

20. The dongle of claim 19, wherein the radio frequency receiver receives further radio frequency signals representing additional remote control commands, the additional commands are communicated to the communication module via the module connector and the base connector, and the additional commands are transmitted via the infrared transmitter,
wherein the additional commands control one or more additional electronic devices.
